(19) United States
(12) Patent Application Publication
(10) Pub. No.: US 2012/0325750 A1
(43) Pub. Date: Dec. 27, 2012

(54) METHOD OF REMOVING METALS FROM A SOLUTION USING LEGUME PLANTS

(75) Inventors: Fei-Ran Li, Shanghai (CN); Shu Li, Shanghai (CN)

(73) Assignee: Empire Technology Development LLC, Wilmington, DE (US)

(21) Appl. No.: 13/121,821

(22) PCT Filed: May 5, 2010
(86) PCT No.: PCT/CN10/72470

§ 371 Date: Mar. 30, 2011

(51) Int. Cl. C02F 1/28; C02F 1/62; C02F 1/58; B01J 20/22

(52) U.S. Cl. 210/688; 502/401; 210/681

(57) ABSTRACT

The present application provides a method for removing a metal from a metal-containing solution, comprising contacting a legume product with the metal-containing solution; and removing the legume product from the solution.

### BACKGROUND

Water containing excessive metals can cause pollution to the environment. Conventional techniques of water treatment include sedimentation, chemical redox reaction, ion exchange, electrochemical treatment and membrane separation. However, application of these methods is limited due to complicated operation, high expenses, and unsatisfactory results.

Adsorption techniques have been used in water treatment because they do not require sophisticated equipment and appear useful for treating water containing a low concentration of metals. The efficacy of the adsorption techniques varies depending on the adsorbents used for the treatment. Various adsorbents have been reported for removing metal contaminants from a solution, including, for example, synthetic adsorbents, natural adsorbents and modified natural adsorbents. However, synthetic adsorbents and modified natural adsorbents are expensive to make and may cause secondary pollution.

In the last decade, biomass such as pecan nutshells, phragmites australis and tobacco stems have been used for removing Cr(VI), Cu(II), Mn(II), Pb(II) and Cd(II) from aqueous solutions (Vaghetti, J. C. P. et al, “Pecan nutshell as biosorbent to remove Cu(II), Mn(II) and Pb(II) from aqueous solutions”, J. Hazard. Mater. 162: 270-280 (2009); Southichak B. H. et al, “Phragmites australis: A novel biosorbent for the removal of heavy metals from aqueous solution”, Water Res., 40(12): 2295-2302 (2006); Li, W. et al, “Tobacco stems as a low cost adsorbent for the removal of Pb(II) from wastewater: Equilibrium and kinetic studies”, Ind. Crops Prod. 28: 294-302 (2008)). More recently, fruit peels such as mango peels and orange peels have been employed as heavy metal ion biosorbents (Iqbal M. et al, “FTIR spectrophotometry, kinetics and adsorption isotherms modeling, ion exchange, and EDX analysis for understanding the mechanism of Cd²⁺ and Pb²⁺ removal by mango peel waste”, J. Hazard. Mater., 164: 161-171(2009); Lugo-Lugo, V. et al, “A comparative study of natural, formaldehyde-treated and copolymer-grafted orange peel for Pb(II) adsorption under batch and continuous mode”, J. Hazard. Mater., 161: 1255-1264 (2009)). However, biosorbents have a lower percentage of adsorption and capacity of adsorption when compared with synthetic adsorbents and modified natural adsorbents.

### SUMMARY

In one aspect, the present disclosure provides a method for removing a metal from a metal-containing solution, including contacting a legume product with the metal-containing solution.

In another aspect, the present disclosure provides a method for removing a metal from a metal-containing solution, including contacting a legume product with the metal-containing solution, and removing the legume product from the solution.

In another aspect, the present disclosure provides a method for removing a metal from a metal-containing solution, including contacting a legume product with the metal-containing solution, and removing the legume product from the solution, in which the legume product excludes soybeans.

In another aspect, the present disclosure provides a method for removing a metal from a metal-containing solution, including contacting a legume product with the metal-containing solution, and removing the legume product from the solution, in which the concentration of the metal in the solution is reduced by at least 5%.

In another aspect, the present disclosure provides a method for removing a metal from a metal-containing solution, including contacting a legume product with the metal-containing solution, and removing the legume product from the solution, in which the concentration of the metal in the solution is no more than 200 mg/L.

In another aspect, the present disclosure provides a product comprising a legume product configured for removing a metal from a metal-containing solution.

The foregoing summary is illustrative only and is not intended to be in any way limiting. In addition to the illustrative aspects, embodiments, and features described above, further aspects, embodiments, and features will become apparent by reference to the following detailed description.

### DETAILED DESCRIPTION

The illustrative embodiments described in the detailed description and claims are not meant to be limiting. Other embodiments may be utilized, and other changes may be made, without departing from the spirit or scope of the subject matter presented herein.

The present disclosure provides a method for removing a metal from a metal-containing solution, including contacting a legume product with the metal-containing solution. In another aspect, the present disclosure provides a method for removing a metal from a metal-containing solution including contacting a legume product with the metal-containing solution, and removing the legume product from the solution.

In certain embodiments, the method for removing a metal from a metal-containing solution includes contacting a legume product with the metal-containing solution, in which the metal is selected from the group consisting of cadmium, mercury, lead, tin, thallium, beryllium and barium. In certain embodiments, the method for removing a metal from a metal-containing solution includes contacting a legume product with the metal-containing solution, and removing the legume product from the solution, in which the metal is selected from the group consisting of cadmium, mercury, lead, tin, thallium, beryllium and barium.

In certain embodiments, the method for removing a metal from a metal-containing solution includes contacting a legume product with the metal-containing solution, in which the legume product excludes soybeans. In certain embodiments, the method for removing a metal from a metal-containing solution includes contacting a legume product with the metal-containing solution, and removing the legume product from the solution, in which the legume product excludes soybeans.

In certain embodiments, the method for removing a metal from a metal-containing solution includes contacting a legume product with the metal-containing solution, in which the legume product excludes soybeans, and in which the metal is selected from the group consisting of cadmium, cobalt, chromium, copper, mercury, manganese, nickel, lead, tin, iron, zinc, thallium, beryllium, and barium. In certain embodiments, the method for removing a metal from a metal-containing solution includes contacting a legume product with the metal-containing solution, and removing the legume product from the solution, in which the legume product excludes soybeans, and in which the metal is selected from the group consisting of cadmium, cobalt, chromium, copper, mercury, manganese, nickel, lead, tin, iron, zinc, thallium, beryllium, and barium.

Metal

The term “metal” as used in the present disclosure refers to both the metallic elements and metalloid elements in the chemical elements periodic table.

Metallic elements include all elements in Group 1 to Group 16 of the periodic table except for hydrogen, carbon, nitrogen, phosphorus, oxygen, sulphur, selenium and the metalloid elements in those groups. In an illustrative embodiment, the metal elements include cadmium, cobalt, chromium, copper, mercury, manganese, nickel, lead, tin, iron, zinc, thallium, beryllium and barium. In another illustrative embodiment, the metal element is cadmium, cobalt, chromium, copper, mercury, manganese, nickel, lead, tin, iron, zinc or any combination thereof. In another illustrative embodiment, the metal element is chromium, copper, mercury, manganese, nickel, lead, tin, iron, zinc or any combination thereof. In another illustrative embodiment, the metal element is mercury, manganese, nickel, lead, tin, iron, zinc or any combination thereof. In another illustrative embodiment, the metal element is nickel, lead, tin, iron, zinc or any combination thereof. In another illustrative embodiment, the metal element is copper, mercury, nickel, lead, iron, zinc or any combination thereof. In another illustrative embodiment, the metal element is copper, mercury, lead, iron, or any combination thereof. In another illustrative embodiment, the metal element is copper, mercury, lead, zinc or any combination thereof.

In another illustrative embodiment, the metal element is selected from the group consisting of cadmium, mercury, lead, tin, thallium, beryllium and barium. In another illustrative embodiment, the metal element is selected from the group consisting of cadmium, mercury, lead and tin. In another illustrative embodiment, the metal element is selected from the group consisting of mercury, lead and tin. In another illustrative embodiment, the metal element is mercury, lead or any combination thereof. In another illustrative embodiment, the metal element is lead. In another illustrative embodiment, the metal element is selected from the group consisting of cadmium, thallium, beryllium and barium.

The term “metalloid element” refers to an element that has properties between that of a metal element and a nonmetal element, especially one that exhibits the external characteristics of a metal but behaves chemically more like a nonmetal. In an illustrative embodiment, the metalloid elements include boron, silicon, germanium, arsenic, antimony, tellurium and polonium. In another illustrative embodiment, the metalloid elements include boron, silicon and arsenic.

In an illustrative embodiment, the metal may be a toxic metal that can cause harm to humans, animals and/or plants. Illustrative examples of toxic metals are aluminum, antimony, barium, beryllium, cadmium, lead, mercury, osmium, thallium and vanadium, and radioactive metals such as thorium, uranium, radium, plutonium and polonium.

Toxic metals may be elements that are not necessary for the normal metabolism of humans, animals and/or plants. Illustrative examples of such toxic metals include, but are not limited to, cadmium, lead, mercury, uranium, radium, vanadium, arsenic and polonium.

On the other hand, toxic metals may be essential elements that are required in humans, animals and/or plants in a small amount but can cause harm when used in an excessive amount. For example, iron is an essential trace element for a human body and the serum iron concentration in an adult is normally 50-150 μg/dL, but an iron concentration of 1000 μg/dL could be potentially lethal (P. Bryson, “Comprehensive review in toxicology for emergency clinicians,” Edition: 3, Chapter 64, p 628 (1996)).

Furthermore, toxic metal may be metal that are beneficial in one form but toxic in another form. In an illustrative embodiment, chromium(III) is an essential trace element, but chromium(IV) is a carcinogen.

A metal may exist in various forms such as solid, liquid and gas. Furthermore, a metal in the metal-containing solution may be present in the form of a metal ion. Metal ions are the ionic forms of a metal after losing or gaining electrons. A metal may have different ionic forms with different electrical charges. For example, iron may be Fe(II), Fe(III) and Fe(IV), copper may be Cu(I), Cu(II), Cu(III) and Cu(IV), arsenic may be As(III) and As(IV), and chromium may be Cr(III), Cr(IV) and Cr(VI). As used herein, Cr(VI) represents any form of chromium ion with 6 positive charges, for example, Cr⁶⁺, CrO₄²⁻, Cr₂O₇²⁻, and Cr(OH₃)³⁺. Similarly, Fe(II), Cu(II), As(III), and similar expressions for other metal ions represent the ionic forms of the corresponding metal with the number of charges as written in the following parenthesis.

A metal-containing solution may be any aqueous liquid containing one or more kinds of metals. It may be wastewater from residential homes, factories, laboratories, offices, restaurants, public facilities, etc. It may also be natural water from river, lake, reservoir, underground, pond, stream, etc. The metal-containing solution may contain one or more metals in one or more forms. In an illustrative embodiment, the metal-containing solution may contain a single kind of metal. In another illustrative embodiment, the metal-containing solution may contain a combination of different ionic forms of the same metal. In another illustrative embodiment, the metal-containing solution may contain a combination of different metals in different forms. In another illustrative embodiment, the metal-containing solution may contain lead and mercury. In another illustrative embodiment, the metal-containing solution may contain lead, copper, and zinc. In another illustrative embodiment, the metal-containing solution may contain lead, mercury, copper, and zinc. In another illustrative embodiment, the metal-containing solution may contain lead, mercury, copper, zinc and iron. In another illustrative embodiment, the metal-containing solution may contain lead, copper, zinc and iron.

The amount of metal contamination in the metal-containing solution may vary by a large range. In an illustrative embodiment, the concentration of a metal in the metal-containing solution is no more than 200 mg/L, 100 mg/L, 50 mg/L, 10 mg/L, 5 mg/L, 1 mg/L or 0.1 mg/L. In another illustrative embodiment, the concentration of a metal in the metal-containing solution ranges from 0.1 mg/L to 100 mg/L. In another illustrative embodiment, the concentration of a metal in the metal-containing solution ranges from 1 mg/L to 200 mg/L. In another illustrative embodiment, the concentration of a metal in the metal-containing solution ranges from 10 mg/L to 1000 mg/L.

The concentration of a metal in the metal-containing solution may be determined by any suitable methods known in the art. In an illustrative embodiment, the concentration of a metal may be measured by a chemical method such as titration (for review please see: D. Harris, “Quantitative chemical analysis,” Edition: 6, published by W. H. Freeman, Chapters 12- 16, p224-347 (2003)). In another illustrative embodiment, the concentration of a metal may be measured by chromatography such as gas chromatography, reversed-phase high performance liquid chromatography, ion chromatography and capillary electrophoresis (for reviews, please see: I. Ali et al, “Instrumental methods in metal ion speciation,” published by Taylor & Francis Group (2006); M. Macka et al, “Determination of metal ions by capillary electrophoresis,” Electrophoresis, 18(12-13): 2482-2501 (2004)). In another illustrative embodiment, the concentration of a metal may be measured by instrument analysis such as atomic absorption spectrometry (AAS), inductively coupled plasma (ICP), inductively coupled plasma-mass spectrometry (ICP-MS), UV-Vis absorption spectrometer, ion selective electrode(ISE), anodic stripping voltammetry (ASV) (for reviews, please see: H. Q. Fang et al, “Instrumental analysis”, published by Science Press, Beijing, China (2002); Y. K. Guo, “Instrumental analysis”, published by Chemical Industry Press, Beijing, China (2006)).

Legume Product

The term “legume product” refers to one or more substances derived from one or more legume plants. A legume plant belongs to the family of Fabaceae (also known as Leguminosae), as classified by the modern system of plant taxonomy (The Angiosperm Phylogeny Group, “An ordinal classification for the families of flowering plants,” Annals of the Missouri Botanical Garden 85: 531-553 (1998)).

The Fabaceae family is commonly known as the legume family, and includes about 730 genera and over 19,400 species. In certain embodiments, the legume plants may include one or more species and/or genera from Acacia genus, Albizia genus, Arachis genus, Cajanus genus, Canavalia genus, Castanospermum genus, Ceratonia genus, Cicer genus, Cyamopsis genus, Erythrina genus, Glycine genus, Indigofera genus, Lablab genus, Lathyrus genus, Lens genus, Leucaena genus, Lupinus genus, Macrotyloma genus, Medicago genus, Phaseolus genus, Pisum genus, Prosopis genus, Sesbania genus, Stizolobium genus, Trifolium genus, Vicia genus, and Vigna genus.

In certain embodiments, the legume plants do not include one or more species and/or genera from Acacia genus, Albizia genus, Arachis genus, Cajanus genus, Canavalia genus, Castanospermum genus, Ceratonia genus, Cicer genus, Cyamopsis genus, Erythrina genus, Glycine genus, Indigofera genus, Lablab genus, Lathyrus genus, Lens genus, Leucaena genus, Lupinus genus, Macrotyloma genus, Medicago genus, Phaseolus genus, Pisum genus, Prosopis genus, Sesbania genus, Stizolobium genus, Trifolium genus, Vicia genus, or Vigna genus.

Illustrative examples of legume plants include, beans (e.g. Phaseolus species), clover (Trifolium species), soybeans (Glycine max), peas (Pisum sativum), horsebeans (Viciafaba), chickpeas (Cicer arietinum), lentils (Lens culinaris), lupins (Lupinus species), mesquite (Prosopis species), carob (Ceratonia siliqua), alfalfa (Medicago sativa), peanuts (Arachis hypogaea) and other Arachis species, Leucaena species, Albizia species, Indigofera species, Acacia species, Cyamopsis species, Sesbania species and Castanospermum species.

In certain embodiments, the legume plants include one or more species from the Glycine genus. In certain embodiments, the legume product may exclude one or more species from Glycine genus. In certain embodiments, the legume product may exclude Glycine max (soybean).

In certain embodiments, the legume product may include one or more species from the Pisum genus. In certain embodiments, the legume product may include one or more species and/or genera of Medicago genus, Pisum genus, Trifolium genus, Vicia genus, Vicer genus, and Astragalus genus. In certain embodiments, the legume product may include Pisum abyssinicum, Pisum fulvum, and Pisum sativum (pea).

In an illustrative embodiment, the legume product is selected from the group consisting of beans, clover, soybeans, peas, horsebeans, chickpeas, lentils, lupins, mesquite, carob, alfalfa and peanuts. In another illustrative embodiment, the legume product is selected from the group consisting of beans, clover, peas, horsebeans, chickpeas, lentils, lupins, mesquite, carob, alfalfa and peanuts. In another illustrative embodiment, the legume product is selected from the group consisting of clover, peas, horsebeans, chickpeas, lentils, lupins, mesquite, carob, alfalfa and peanuts. In an illustrative embodiment, the legume product is selected from the group consisting of peas and soybeans. In an illustrative embodiment, the legume product is peas.

A legume product may contain the entire legume plant or a portion of the legume plant such as the fruits, stems, leaves, roots, shells, seeds, or any combination thereof. The legume product may be used in any suitable form in the methods described herein. In an illustrative embodiment, legume plants are collected from the fields and directly used in their natural form. In another illustrative embodiment, legume fruits or legume shells are taken from legume plants and used in the methods. In another illustrative embodiment, legume plants are pretreated. In another illustrative embodiment, legume plants are pretreated by drying under the sun or by a machine before use. In another illustrative embodiment, legume fruits or legume shells are pretreated by cutting into smaller pieces before use. In another illustrative embodiment, legume fruits or legume shells are pretreated by smashing or grinding before use. In another illustrative embodiment, the legume product is legume shells, cut legume shells or any combination thereof.

Contact

A legume product may be contacted with a metal-containing solution in any manner that is suitable for removing metal(s) from the solution. In an illustrative embodiment, the legume product is mixed with the metal-containing solution and incubated with stirring for a period of time. In another illustrative embodiment, the metal-containing solution is passed through a flow chamber filled with legume products. In another illustrative embodiment, the metal-containing solution is passed through an adsorption bed packed with legume products. In another illustrative embodiment, the metal-containing solution is passed through a filter adsorption vessel filled with legume products. In another illustrative embodiment, the metal-containing solution is passed through a membrane made of legume products.

In certain embodiments, the metal-containing solution is contacted with the legume product at a selected incubation temperature. The incubation temperature may vary due to factors such as the type of metal to be removed, the concentration of the metal in the solution, the type of legume product, the amount of legume product used, the incubation time, and so on. The incubation temperature may be determined as appropriate by the person practicing the method. In certain illustrative embodiments, the incubation temperature may range from 0° C. to 60° C., from 0° C. to 50° C., from 10° C. to 50° C., from 20° C. to 50° C., from 20° C. to 40° C., from 20° C. to 30° C., or from 30° C. to 40° C. In certain illustrative embodiments, the incubation temperature may be about 10° C., 15° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 45° C., 50° C., 55° C., or 60° C.

In certain illustrative embodiments, the metal-containing solution may be contacted with the legume product for a suitable period of incubation time. The incubation time may vary due to factors such as the type of metal to be removed, the concentration of the metal(s) in the solution, the type of legume product, the amount of legume product used, the incubation temperature, and so on. The incubation time may be determined as appropriate by the person practicing the method. In certain illustrative embodiments, the incubation time may be from 1 minute to 2 weeks, 1 minute to 1 week, 1 minute to 2 days, 1 minute to 1 day, 1 minute to 12 hours, from 1 minute to 6 hours, from 10 minutes to 6 hours, from 0.5 hour to 6 hours, from 0.5 hour to 5 hours, from 0.5 hour to 4 hours, from 0.5 hour to 3 hours, from 0.5 hour to 2 hours, or from 1 hour to 2 hours. In certain illustrative embodiments, the incubation time is at least 1 minute, 10 minutes, 0.5 hour, 1 hour, 1.5 hours, 2 hours, 2.5 hours, 3 hours, 3.5 hours, 4 hours, 4.5 hours, 5 hours, 5.5 hours, 6 hours, 12 hours, 1 day, 2 days, 1 week, or 2 weeks. In certain illustrative embodiments, the incubation time is 1 hour.

The legume product used to contact with the metal-containing solution may be in a suitable amount for effective metal removal from the solution. The amount of the legume product may vary due to factors such as the type of metal(s) to be removed, the concentration of the metal in the solution, the type of legume product, the incubation temperature, the incubation time and so on. The amount of the legume product may be determined as appropriate by the person practicing the method. In certain illustrative embodiments, the amount of the legume product used to contact with the solution is at least 1 g/L, 1.2 g/L, 2 g/L, 3 g/L, 4 g/L, 5 g/L, 8 g/L, 10 g/L or 12 g/L of the volume of the solution. In certain illustrative embodiments, the amount of the legume product used to contact with the solution ranges from 1 g/L to 30 g/L, from 1 g/L to 25 g/L, from 1 g/L to 20 g/L, from 1.2 g/L to 20 g/L, from 1 g/L to 18 g/L, from 1 g/L to 16 g/L, from 1 g/L to 14 g/L, or from 1 g/L to 12 g/L of the volume of the solution.

The legume products may be removed from the solution using any suitable methods known in the art. In an illustrative embodiment, the legume products may be removed from the solution by filtration using a suitable filter. In another illustrative embodiment, the legume products may be removed from the solution by taking away floating or precipitated legume products from the solution. In another illustrative embodiment, the legume products may be removed from the solution by precipitating the legume products through centrifugation, and separating the solution from the precipitates. In another illustrative embodiment, the legume products are removed from the solution by precipitating the legume products to the bottom of the solution.

After treatment with the legume products, the metal-containing solution will have no metal or a reduced amount of metal(s) when compared with the initial metal concentration before the treatment. The percentage of reduction in metal concentration in the solution may be calculated using the following equation (1):

$$q = \frac{( {C}_{0} - {C}^{′} )}{{C}_{0}} \times 100 \% , \qquad ( 1 )$$

wherein q is the percentage of reduction in metal concentration in the solution, also called the adsorption percentage; C₀ is the initial concentration of the metal in the solution before treatment; C′ is the residual concentration of the metal in the solution after treatment. In certain illustrative embodiments, the metal concentration in the solution after contacting with the legume product may be reduced by at least 3%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90%. In certain illustrative embodiments, the metal concentration in the solution after contacting with the legume product may be less than 1 mg/L.

In certain embodiments, the method provided in the present disclosure may be repeated for one or more times for a metal-containing solution. When repeated, the method may be performed under the same conditions as the previous treatment, or under different conditions as determined appropriate by the person practicing the method, such as different incubation temperature, incubation time, amount of legume products, etc.

The legume product described herein may be used in combination with one or more other adsorbents for removing metal(s) from a solution. The other adsorbents may be synthetic adsorbents or any other natural adsorbents. Examples of synthetic adsorbents include activated carbon, polyurethane polymer, polypropylene, polystyrene, polymethyl metharcrylate, polyphenylenediamine microparticles and chelating resin. Examples of other natural adsorbents include mineral adsorbents such as natural zeolite, clay, perlite, spent lime, calcium carbonate and rock wool, and biosorbents such as pecan nutshells, tobacco stems, mango peels and orange peels. The legume products and the other adsorbents may be used together or sequentially in contacting with the metal-containing solution.

A method described herein may be used in combination with any other method suitable for treating or cleaning a metal-containing solution. The methods described herein and the other methods may be performed either simultaneously or sequentially. There are various methods known for water treatment or cleaning. In an illustrative embodiment, a method provided in the present disclosure may be combined with a precipitation method. The precipitation method may include introducing to the metal-containing solution a precipitation agent capable of forming precipitates with one or more metal ions. The precipitation agent in the solution may release anions such as Cl⁻, Br⁻, SO₄²⁻, CO₃²⁻, S²⁻, Cr₂O₄²⁻, PO₄²⁻ and OH⁻ etc, which can form precipitates with metal ions. When a metal-containing solution has a high metal concentration (e.g. 200 mg/L or more), the precipitation method may be used before using the legume product to remove the metals as described herein.

In another illustrative embodiment, a method provided in the present disclosure may be used in combination with a separation method. The separation method may include separating any insoluble substances from the metal-containing solution. Insoluble substances may be solid substances or liquid substances that do not dissolve in water (e.g. oil). Illustrative examples of separation methods are filtration and adsorption. In an illustrative embodiment, wastewater from a printery is filtered before treating with the legume products. In another illustrative embodiment, wastewater containing high oil content is treated with an absorbent for oil before treating with the legume products.

In another illustrative embodiment, the method provided in the present disclosure may be used in combination with a pH adjustment method. The pH adjustment method may include introducing acid or base to the metal-containing solution to make the solution desirable for contacting with the legume product. The pH adjustment method may be used to treat a highly acidic or highly basic metal-containing solution before treating with the legume products.

In certain embodiments, the legume product contacted with the metal-containing solution may be regenerated for a reuse. The used legume product may be regenerated by any suitable methods known in the art. In certain embodiments, the regeneration of the legume product may involve removal of metal ions from the legume product. In an illustrative embodiment, the used legume product is washed with an acidic solution to release the metal ions adsorbed to the legume products. Illustrative examples of acidic solutions include inorganic acids such as hydrochloric acid, sulfuric acid, and nitric acid. In another illustrative embodiment, the used legume product is washed with a chelator solution for desorption of the metal ions. Illustrative examples of chelator solutions include EDTA solution. The regenerated legume product may be used again directly or may be used again after further treatment, such as drying.

In another aspect, the present disclosure provides a product comprising a legume product configured for removing a metal from a metal-containing solution.

In certain embodiments, the legume product may be from one or more legume plant selected from the group consisting of beans, clover, soybeans, peas, horsebeans, chickpeas, lentils, lupins, mesquite, carob, alfalfa and peanuts. In certain embodiments, the legume plant is selected from the group consisting of peas and soybeans.

In certain embodiments, the legume product is pretreated. In an illustrative embodiment, legume plants are pretreated by drying under the sun or by a machine before use. In another illustrative embodiment, legume fruits or legume shells are pretreated by cutting into smaller pieces before use. In another illustrative embodiment, legume fruits or legume shells are pretreated by smashing or grinding before use. In another illustrative embodiment, the legume product is cut legume shells.

### EXAMPLES

The following Examples are set forth to aid in the understanding of the present disclosure, and should not be construed to limit in any way the scope of the invention as defined in the claims which follow thereafter.

### Example 1

### Adsorption of Metal Ions From Metal Containing Solutions

Soybean shells, pea shells and horsebean shells are used to adsorb metal ions from metal containing solutions separately. Each solution contains one metal ion, including Pb(II), Hg(II), Cr(VI), Fe(III) or Zn(II), and the initial concentration of the metal ion in each solution before adsorption is 200 mg/L. Before adsorption, soybean shells, pea shells and horsebean shells are washed with water and smashed in a shredder for 30-60 seconds, respectively. The smashed shells are squeezed to extract water, and dried under the sunlight for 1 to 2 days to obtain soybean shells, pea shells and horsebean shells for use in the adsorption.

300 mg of soybean shells, pea shells or horsebean shells are added respectively to 25 mL metal-containing solution which is placed in water bath at 30° C. in advance. The mixture is stirred with a magnetic bar for 2 hours. The mixture is then filtered to remove the pea shells or the soybean shells. The residual metal ion concentration in the filtrate is determined by EDTA titration. The adsorption percentages (q) of the metal ions are calculated according to equation (1),

$$q = \frac{( {C}_{0} - {C}^{′} )}{{C}_{0}} \times 100 \% , \qquad ( 1 )$$

wherein q is the percentage of reduction in metal concentration in the solution, also called the adsorption percentage; C₀ is the initial concentration of the metal in the solution before treatment; C′ is the residual concentration of the metal in the solution after treatment. The results are shown in Table 1.

TABLE 1
Adsorption of metal ions by pea shells,
soybean shells and horsebean shells

| | Adsorption percentage (%) | | | | |
|---|---|---|---|---|---|
| Legume products | Pb(II) | Hg(II) | Cr(VI) | Fe(III) | Zn(II) |
| Pea shells | 85.5 | 57.7 | 2.7 | 2.9 | 67.5 |
| Soybean shells | 89.6 | 43.2 | 1.8 | 10.9 | 52.4 |
| Horsebean shells | 38.1 | 29.0 | N/D* | N/D | N/D |

*N/D: no data. The adsorption percentages of horsebean shells on Cr(VI), Fe(III), Zn(II) are not tested.

Pea shells and soybean shells adsorb a significant amount of Pb(II), and the adsorption percentages of Pb(II) reach 85.5% and 89.6%, respectively. For comparison, the adsorption percentages of Pb(II) by crumbs of used cotton knitwear and corn husk are 25.4% and 40.9%, respectively, which are significantly lower than those achieved by pea shells and soybean shells. The results also show that pea shells or soybean shells can adsorb Hg(II), Cr(VI), Fe(III) and Zn(II) from the solutions though the adsorption percentages for Cr(VI) and Fe(III) are lower than for the other metal ions. The horsebean shells also show effective adsorption of Pb(II) and Hg(II), with the adsorption percentages of 38.1% and 29.0%, respectively.

The adsorption of Pb(II) by pea shells and soybean shells is further measured at different time points. Pb(II) adsorption percentage is measured after incubation for 5 minutes, 10 minutes, 20 minutes, 30 minutes, 60 minutes, 120 minutes, and 240 minutes, respectively. During the incubation, the mixtures are stirred with a magnetic bar. The residual Pb(II) concentrations in the filtrates are determined by EDTA titration, and the adsorption percentages (q) of Pb(II) are calculated as described above. The results are shown in Table 2.

TABLE 2
Adsorption of Pb(II) after incubation with pea shells
and soybean shells for different incubation time

Adsorption percentage (%)

| Incubation time (min) | Pea shells | Soybean shells |
|---|---|---|
| 5 | 61.4 | 67.8 |
| 10 | 68.4 | 70.1 |
| 20 | 74.3 | 78.2 |
| 30 | 78.6 | 83.3 |
| 60 | 86.7 | 86.8 |
| 120 | 88.9 | 89.6 |
| 240 | 88.6 | 89.3 |

### Example 2

### Adsorption of Pb(II) and Hg(II) From a Solution

The adsorption percentage of Pb(II) and Hg(II) by legume shells are tested using a mixed solution containing equal concentration of both metal ions. Pea shells and soybean shells are prepared using the same method as described in Example 1. Before adsorption, the mixed solution is placed in water bath at 30° C. Two sets of mixed solutions are tested, one contains 1.0 mg/L Pb(II) and 1.0 mg/L Hg(II), and the other contains 5.0 mg/L Pb(II) and 5.0 mg/L Hg(II).

For adsorption, 25 mL mixed solution is incubated with 300 mg pea shells or 300 mg soybean shells. The mixtures are stirred with a magnetic bar for 2 hours at 30° C. The pea shells or soybean shells are filtered to obtain clear solution. The residual concentrations of Pb(II) and Hg(II) are tested using inductively coupled plasma mass spectrometry, and the adsorption percentages of Pb(II) and Hg(II) by pea shells and soybean shells are calculated as described above. The results are shown in Table 3.

TABLE 3
Adsorption of Pb(II) and Hg(II) ions
by pea shells and soybean shells

| | Initial | Residual | | Adsorption | |
|---|---|---|---|---|---|
| | concentration | concentration (mg/L) | | percentage(%) | |
| Legumes | (mg/L) | Pb(II) | Hg(II) | Pb(II) | Hg(II) |
| Pea | 1.0 | 0.0638 | 0.3310 | 93.6 | 66.9 |
| shells | 5.0 | 0.4585 | 1.7801 | 90.8 | 64.4 |
| Soybean | 1.0 | 0.1260 | 0.3928 | 87.4 | 60.7 |
| shells | 5.0 | 0.6579 | 2.7760 | 86.8 | 55.6 |

### Example 3

### Adsorption of Heavy Metal Ions in River Water

Pea shells or soybean shells are used to adsorb heavy metal ions in river water. Pea shells and soybean shells are prepared using the same method as described in Example 1. Before adsorption, a sample of river water is filtered through filter paper for 3 to 4 times to obtain clear water. The heavy metal ion concentrations in the obtained clear filtrate are determined by inductively coupled plasma mass spectrometry. The heavy metal ions detected in the untreated filtrate are: Pb(II), Cu(II), Fe(II), Fe(III) and Zn(II), and the concentrations of these metal ions in the filtrate are shown in Table 4.

Before adsorption, 25 mL filtrate is transferred to a beaker and placed in water bath at 30° C. 300 mg pea shells or 300 mg soybean shells are added respectively to the pre-warmed filtrate, and the mixture is stirred with a magnetic bar for 2 hours. The mixture is then filtered to remove the pea shells or the soybean shells. The filtrate after adsorption is tested by inductively coupled plasma mass spectrometry to determine the residual concentrations of the heavy metal ions. The results are shown in Table 4. The adsorption percentages are calculated as described above.

TABLE 4
Adsorption of heavy metal ions by pea shells
and soybean shells in river water

| | | Residual | | Adsorption | |
|---|---|---|---|---|---|
| | Initial | concentration (mg/L) | | percentage (%) | |
| | concentration | Pea | Soybean | Pea | Soybean |
| Metal ion | (mg/L) | shells | shells | shells | shells |
| Pb(II) | 0.4242 | 0.0080 | 0.0445 | 98.1 | 89.5 |
| Cu(II) | 0.1385 | 0.1337 | 0.1157 | 3.5 | 16.5 |
| Fe(II) | 0.1919 | 0.1639 | 0.1617 | 14.6 | 15.7 |
| Fe(III) | | | | | |
| Zn(II) | 0.0134 | 0.0109 | 0.0091 | 18.6 | 32.1 |

### Example 4

### Adsorption of Heavy Metal Ions in Printery Wastewater

Pea shells or soybean shells are used to adsorb heavy metal ions in a printery wastewater sample. Pea shells and soybean shells are prepared using the same method as described in Example 1. Before adsorption, the printery wastewater sample is filtered through filter paper for 3 to 4 times until the filtrate is clear, and the heavy metal ion concentrations in the filtrate are determined by inductively coupled plasma mass spectrometry. Five heavy metal ions are detected in the filtrate: Pb(II), Cu(II), Fe(III,), Fe(II) and Zn(II). The concentrations of these metal ions in the filtrate are shown in Table 5.

50 mL filtrate is transferred to a beaker and placed in water bath at 30° C. in advance of adsorption. 600 mg pea shells or 600 mg soybean shells are added respectively to the pre-warmed filtrate, followed by stirring with a magnetic bar for 2 hours. Then the mixture is filtrated to remove the pea shells or the soybean shells. The residual concentrations of the heavy metal ions in filtrate after adsorption are measured by inductively coupled plasma mass spectrometry. The adsorption percentages are calculated using Equation (1), and the first adsorption results are shown in Table 5.

After the first adsorption, the obtained filtrate is treated again using pea shells or soybean shells. 25 mL of the obtained filtrate is treated with another 300 mg pea shells or 300 mg soybean shells, using the same procedures as the first adsorption. The second adsorption results are shown in Table 5.

The results show that the Pb(II) ion concentration in printery wastewater decreases from 6.796 mg/L to 0.0118 mg/L with the adsorption percentage of 99.8% after two successive treatments using pea shells, and decreases from 6.796 mg/L to 0.0821 mg/L after two successive treatments using soybean shells. Pea shells and soybean shells also adsorbed significant amount of Zn(II), Cu(II), Fe(II) and Fe(III) found in the sample.

TABLE 5
Adsorption of heavy metal ions by pea shells and soybean shells in printery wastewater sample

| | | 1st adsorption treatment | | | | 2nd adsorption treatment | | | |
|---|---|---|---|---|---|---|---|---|---|
| | | Residual | | Adsorption | | Residual | | Adsorption | |
| | Initial | concentration (mg/L) | | percentage (%) | | concentration (mg/L) | | percentage (%) | |
| | Conc. | Pea | Soybean | Pea | Soybean | Pea | Soybean | Pea | Soybean |
| Metal ion | (mg/L) | shells | shells | shells | shells | shells | shells | shells | shells |
| Pb(II) | 6.796 | 0.2781 | 0.8291 | 95.9 | 87.8 | 0.0118 | 0.0821 | 99.8 | 98.8 |
| Cu(II) | 0.0490 | 0.0452 | 0.0403 | 7.8 | 17.8 | 0.0433 | 0.0382 | 11.6 | 22.0 |
| Fe(II) | 0.1736 | 0.1410 | 0.1361 | 18.8 | 21.6 | 0.1225 | 0.1105 | 29.4 | 36.3 |
| Fe(III) | | | | | | | | | |
| Zn(II) | 0.5838 | 0.2334 | 0.2177 | 60.0 | 62.7 | 0.1089 | 0.1803 | 81.3 | 69.1 |

### Example 5

### Adsorption of Heavy Metal Ions by Orange Peel and Bagasse

Orange peel and bagasse are used to adsorb metal ions from metal containing solutions, respectively. Each solution contains one metal ion such as Pb(II) and Hg(II). The initial concentration of the metal ion in each solution before adsorption is 50 mg/L or 200 mg/L. Before adsorption, the orange peel and bagasse are washed with water and smashed in a shredder for 30-60 seconds, respectively. The smashed orange peels and bagasse are squeezed to extract water, and dried under the sunlight for 1 to 2 days to obtain orange peel adsorbent and bagasee adsorbent, respectively, for use in the adsorption.

300 mg of orange peel adsorbent and bagasse adsorbent are added respectively to 25 mL metal containing solution which is placed in a water bath at 30° C. in advance. The mixture is stirred with a magnetic bar for 2 hours. The mixture is then filtered to remove the pea shells or the soybean shells. The residual metal ion concentration in the filtrate is determined by EDTA titration. The adsorption percentages of the metal ions are calculated as described above. The results are shown in Table 6.

According to the results, orange peel and bagasse both show moderate adsorption of Pb(II) and Hg(II) at the tested metal ion concentrations. The adsorption percentage decreases to around 50% as the concentration of metal ions increases from 50 mg/L to 200 mg/L. Such adsorption percentage is significantly lower than that demonstrated by legume shells in Example 1 (above 85%).

TABLE 6
Adsorption of heavy metal ions by orange peel and bagasse

| | |
|---|---|
| Initial concentration | Adsorption percentage (%) |

| Metal ion | (mg/L) | orange peel | bagasse |
|---|---|---|---|
| Pb(II) | 50 | 70.2 | 69.1 |
| | 200 | 50.3 | 62.8 |
| Hg(II) | 50 | 60.1 | 47.2 |
| | 200 | 52.8 | 44.3 |

General

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g.,“a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells and so forth.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for removing a metal from a metal-containing solution, comprising contacting a legume product with the metal-containing solution, wherein the metal is selected from the group consisting of cadmium, mercury, lead, tin, thallium, beryllium and barium, wherein the legume product is pretreated before contacting with the metal-containing solution with a step consisting essentially of contacting the legume product with an aqueous solution consisting of water.

2. The method of claim 1, further comprising removing the legume product from the metal-containing solution.

3. The method of claim 1, wherein the metal is selected from the group consisting of mercury, lead and tin.

4. (canceled)

5. The method of claim 1, wherein the metal is selected from the group consisting of cadmium, thallium, beryllium and barium.

6. The method of claim 1, wherein the legume product is from one or more legume plant selected from the group consisting of beans, clover, soybeans, peas, horsebeans, chickpeas, lentils, lupins, mesquite, carob, alfalfa and peanuts.

7. The method of claim 6, wherein the legume plant is selected from the group consisting of peas and soybeans.

8. The method of claim 1, wherein the legume product is legume shells or cut legume shells, or any combination thereof.

9. The method of claim 1, wherein the concentration of the metal in the metal-containing solution is no more than 200 mg/L.

10. The method of claim 9, wherein the concentration of the metal is no more than 10 mg/L.

11. The method of claim 1, wherein the amount of the legume product used is at least 1.2 g/L of the volume of the metal-containing solution.

12. The method of claim 11, wherein the amount of the legume product used in the solution is at least 12 g/L of the volume of the metal-containing solution.

13. The method of claim 1, wherein the legume product and the solution are incubated at a temperature ranging from 0° C. to 60° C.

14. The method of claim 13, wherein the temperature ranges from 20° C. to 40° C.

15. The method of claim 1, wherein the legume product and the metal-containing solution are incubated for an incubation time ranging from 1 minute to 6 hours.

16. The method of claim 15, wherein the incubation time ranges from 0.5 hour to 4 hours.

17. The method of claim 16, wherein the incubation time ranges from 1 hour to 2 hours.

18. The method of claim 1, wherein the concentration of the metal in the metal-containing solution after contacting with the legume product is reduced by at least 5%.

19. The method of claim 18, wherein the concentration of the metal in the metal-containing solution after contacting with the legume product is reduced by at least 10%.

20. An adsorbent for moving metals from wastewater, the adsorbent comprising a legume product pretreated with an aqueous solution consisting of water.

21. A method for removing a metal from a metal-containing solution, comprising contacting a legume product with the metal-containing solution, wherein the metal is selected from the group consisting of cadmium, mercury, lead, tin, thallium, beryllium and barium, wherein the legume product is pretreated with water before contacting with the metal-containing solution, and wherein the pretreatment does not comprise adjusting the pH.
